(19) United States
(12) Patent Application Publication
(10) Pub. No.: US 2010/0062707 A1
(43) Pub. Date: Mar. 11, 2010

(54) FREQUENCY CONVERSION DEVICE, METHOD AND SYSTEM

(75) Inventors: Haiou Gou, Shenzhen (CN); Tinghai Lv, Shenzhen (CN); Jianjun Yang, Shenzhen (CN); Dejun Li, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/491,504

(22) Filed: Jun. 25, 2009

(30) Foreign Application Priority Data
Sep. 5, 2008 (CN) 200810212223.9

(51) Int. Cl. H04B 7/14

(52) U.S. Cl. 455/15; 455/20

(57) ABSTRACT

A frequency conversion device, method, and system are described. The device includes a first intermediate frequency (IF) filter, a first local oscillator, an up frequency converter, and a first duplexer. The first IF filter is adapted to receive an IF signal, and send the IF signal after performing an IF filtering on the IF signal. The up frequency converter is adapted to receive the IF signal after the IF filtering and a local oscillator signal, perform an up frequency conversion on the IF signal to obtain a microwave signal according to the local oscillator signal, and send the microwave signal. The first duplexer is adapted to receive the microwave signal, and send the microwave signal after performing a band pass filtering on the microwave signal. By the use of the frequency conversion device, the frequency conversion of a digital microwave outdoor unit (ODU) once is thus realized.

### CROSS-REFERENCE TO RELATED APPLICATIONS

This application claims priority to Chinese Patent Application No. 200810212223.9, filed on Sep. 5, 2008, which is incorporated herein by reference in its entirety.

### FIELD OF THE INVENTION

The present invention relates to a digital microwave communication technology field, and more particularly to a frequency conversion device, method and system.

### BACKGROUND

In a digital microwave system, plesiochronous digital hierarchy (PDH) and synchronous digital hierarchy (SDH) signals are transmitted in a wireless manner. The digital microwave system is composed of an indoor unit (IDU) and an outdoor unit (ODU).

The ODU is installed and maintained outdoors, so the ODU having a small volume and weight is conveniently installed and maintained. Meanwhile, in a digital microwave system, because of the technical difficulty and the price of device, the cost of the ODU accounts for nearly a half of the cost of the whole digital microwave system. It is recently a hot spot attracting much attention how to lower the volume, weight, power consumption, and cost of the ODU.

When the digital microwave system is working, the IDU sends an intermediate frequency (IF) signal to the ODU, the ODU performs an up frequency conversion on the IF signal and amplifies the IF signal to achieve an appropriate frequency and power, and transmits the IF signal to a next ODU via an antenna. The next ODU receives the signal, performs a down frequency conversion on the signal, amplifies the signal, and sends the signal to the IDU. The IDU demodulates the signal transmitted by the previous ODU. Therefore, the signal transmission is realized.

A feature of the ODU is that the transmitting and receiving frequencies are both quite high, being up to 6-38 GHz, but the frequencies of the IDU are quite low, being usually hundreds of MHz. Therefore, when the signal is transmitted, the signal having the low frequency of the IDU has to be converted to the signal having the transmitting frequency of the ODU; and when the signal is received, a microwave signal having a quite high frequency of ODU has to be converted to the signal having the frequency band capable of being processed by the IDU. In the prior art, the frequency change is realized through performing frequency conversion twice.

During the process of realizing the present invention, the inventor find that the prior art at least has the problems as follows.

In the prior art, excessive devices are used when performing frequency conversion twice, so that the cost is relatively high, transmit link and receive link are long, and the volume and the weight of the ODU are thus increased. Meanwhile, the excessive active devices result in that the power consumption of the whole system is quite high.

### SUMMARY

The present invention provides a frequency conversion device, method and system, capable of realizing frequency conversion of a digital microwave ODU once, thus reducing the amount of components, and lowering the weight, volume, cost, and power consumption of the device.

The present invention provides a frequency conversion sending device, which includes a first IF filter, a first local oscillator, an up frequency converter, and a first duplexer.

The first IF filter is adapted to receive an IF signal, and send the IF signal after performing an IF filtering on the IF signal.

The first local oscillator is adapted to generate and send a local oscillator signal.

The up frequency converter is adapted to receive the IF signal after the IF filtering and the local oscillator signal, perform an up frequency conversion on the IF signal to obtain a microwave signal according to the local oscillator signal, and send the microwave signal.

The first duplexer is adapted to receive the microwave signal, and send the microwave signal after performing a band pass filtering on the microwave signal.

The present invention further provides a frequency conversion receiving device, which includes a second duplexer, a second local oscillator, a down frequency converter, and a second IF filter.

The second duplexer is adapted to receive a microwave signal, and send the microwave signal after performing a band pass filtering on the microwave signal received.

The second local oscillator is adapted to generate and send a local oscillator signal.

The down frequency converter is adapted to receive the microwave signal after the band pass filtering and the local oscillator signal, perform a down frequency conversion on the microwave signal to obtain an IF signal according to the local oscillator signal, and send the IF signal.

The second IF filter is adapted to receive the IF signal, perform an IF filtering on the IF signal received to obtain a filtered signal.

The present invention provides a frequency conversion sending method, which includes steps as follows.

A first IF filter receives an IF signal, and sends the IF signal after performing an IF filtering on the IF signal.

A first local oscillator generates and sends a local oscillator signal.

An up frequency converter receives the IF signal after the IF filtering and the local oscillator signal, performs an up frequency conversion on the IF signal to obtain a microwave signal according to the local oscillator signal, and sends the microwave signal.

A first duplexer receives the microwave signal, and sends the microwave signal after performing a band pass filtering on the microwave signal.

The present invention further provides a frequency conversion receiving method, which includes steps as follows.

A second duplexer receives a microwave signal, and sends the microwave signal after performing a band pass filtering on the microwave signal.

A second local oscillator generates and sends a local oscillator signal.

A down frequency converter receives the microwave signal after the band pass filtering and the local oscillator signal, performs a down frequency conversion on the microwave signal to obtain an IF signal according to the local oscillator signal, and sends the IF signal.

A second IF filter receives the IF signal, and performs an IF filtering on the IF signal to obtain a filtered signal.

The present invention further provides a frequency conversion system, which includes a frequency conversion sending device and a frequency conversion receiving device.

The frequency conversion sending device is adapted to receive an IF signal, perform an IF filtering on the IF signal, generate a local oscillator signal, perform an up frequency conversion on the IF signal after the IF filtering to obtain a microwave signal according to the local oscillator signal, and send the microwave signal after performing a band pass filtering on the microwave signal.

The frequency conversion receiving device is adapted to receive the microwave signal from the frequency conversion sending device, perform the band pass filtering again on the microwave signal, generate a local oscillator signal, perform a down frequency conversion on the microwave signal after performing the band pass filtering again to obtain an IF signal according to the local oscillator signal, and perform the IF filtering on the IF signal to obtain a filtered signal.

As compared with the prior art, the embodiments of the present invention have advantages as follows.

By the use of the frequency conversion device according to the embodiments of the present invention, frequency conversion of the digital microwave ODU once is realized, and the frequency conversion is easily realized. Further, the amount of components is reduced, thereby lowering the weight, volume, cost, and power consumption of the device.

### BRIEF DESCRIPTION OF THE DRAWINGS

FIG. 1 is a structural view of a frequency conversion sending device according to an embodiment of the present invention;

FIG. 2 is a structural view of a frequency conversion receiving device according to an embodiment of the present invention;

FIG. 3 is a structural view of a frequency conversion sending device according to a first embodiment of the present invention;

FIG. 4 is a structural view of a frequency conversion receiving device according to a second embodiment of the present invention;

FIG. 5 is a flow chart of a frequency conversion sending method according to an embodiment of the present invention;

FIG. 6 is a flow chart of a frequency conversion receiving method according to an embodiment of the present invention; and

FIG. 7 is a structural view of a frequency conversion system according to an embodiment of the present invention.

### DETAILED DESCRIPTION

The present invention provides a frequency conversion device, method and system, so as to eliminate effects in the prior art such as excessive devices, high cost, long transmit link and receive link, and high power consumption of the system.

The implementation manner of the present invention is further described with accompanying drawings and embodiments below.

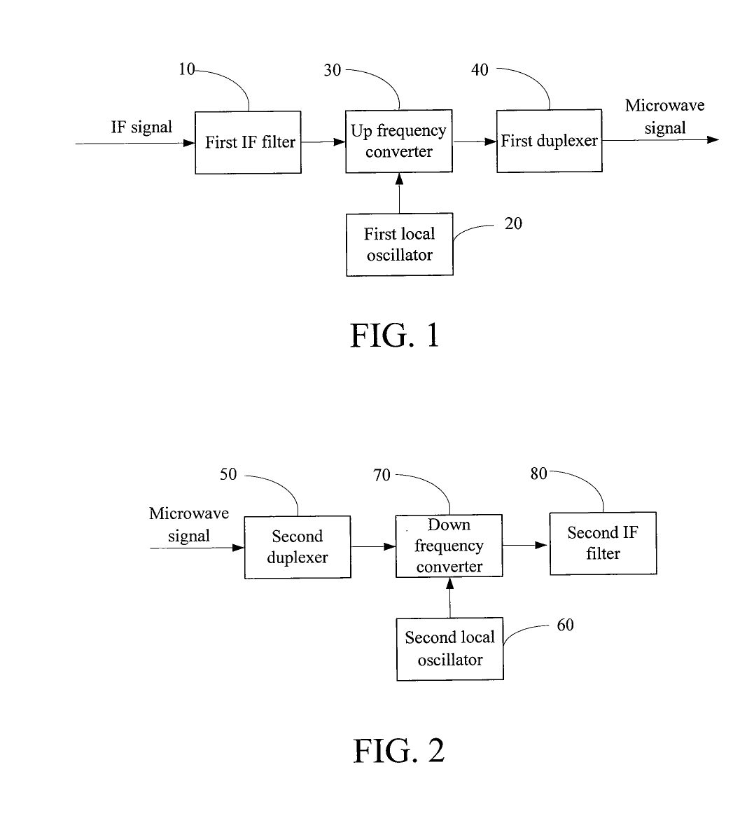

Referring to FIG. 1, a frequency conversion sending device according to an embodiment of the present invention is shown, which includes a first IF filter 10, a first local oscillator 20, an up frequency converter 30, and a first duplexer 40.

The first IF filter 10 is adapted to receive an IF signal, and send the IF signal after performing an IF filtering on the IF signal.

The first local oscillator 20 is adapted to generate and send a local oscillator signal.

The up frequency converter 30 is adapted to receive the IF signal after the IF filtering and the local oscillator signal, perform an up frequency conversion on the IF signal to obtain a microwave signal according to the local oscillator signal, and send the microwave signal.

The first duplexer 40 is adapted to receive the microwave signal, and send the microwave signal after performing a band pass filtering on the microwave signal.

Referring to FIG. 2, a frequency conversion receiving device according to an embodiment of the present invention is shown, which includes a second duplexer 50, a second local oscillator 60, a down frequency converter 70, and a second IF filter 80.

The second duplexer 50 is adapted to receive a microwave signal, and send the microwave signal after performing a band pass filtering on the microwave signal.

The second local oscillator 60 is adapted to generate and send a local oscillator signal.

The down frequency converter 70 is adapted to receive the microwave signal after the band pass filtering and the local oscillator signal, perform a down frequency conversion on the microwave signal to obtain an IF signal according to the local oscillator signal, and send the IF signal.

The second IF filter 80 is adapted to receive the IF signal, perform an IF filtering on the IF signal to obtain the filtered signal.

By the use of the frequency conversion device according to the embodiments of present invention, frequency conversion of a digital microwave ODU once is realized, the frequency conversion is easily realized. Further, the amount of components is reduced, thereby lowering the weight, volume, cost, and power consumption of the device.

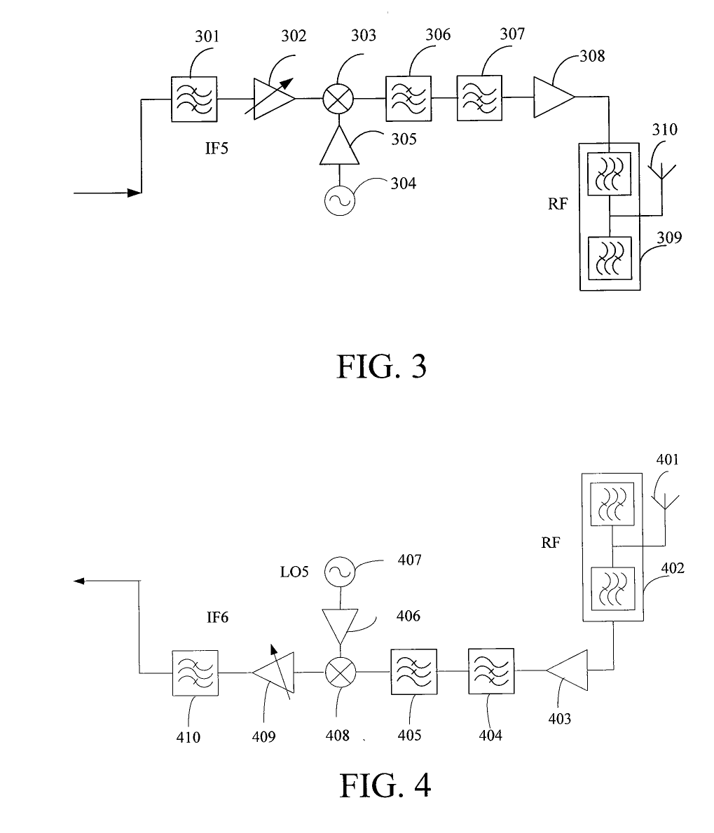

In a first embodiment of the present invention, the structure of the frequency conversion sending device is described by setting a transmit link of an ODU as an example. Referring to FIG. 3, the frequency conversion device includes an IF filter 301, an IF amplifier 302, an up frequency converter 303, a local oscillator 304, an amplifier 305, a low pass filter 306, a high pass filter 307, a power amplifier 308, a duplexer 309, and an antenna 310. Particularly, detailed principles and functions of each part in the frequency conversion sending device are realized as follows.

The IF filter 301 is adapted to perform an IF filtering on an IF signal IF5 received, and send a filtered signal to the IF amplifier 302.

The IF amplifier 302 is adapted to amplify the filtered signal received, and send an amplified signal to the up frequency converter 303.

The up frequency converter 303 is adapted to perform a frequency conversion on the amplified signal received to obtain a microwave signal, and send the microwave signal to the low pass filter 306. Particularly, the local oscillator 304 provides a radio frequency signal serving as a local oscillator signal, the amplifier 305 amplifies the local oscillator signal and sends the local oscillator signal to the up frequency converter 303, and the up frequency converter 303 performs the frequency conversion.

The low pass filter 306 is adapted to perform a low pass filtering on the microwave signal received, and send a filtered signal to the high pass filter 307.

The high pass filter 307 is adapted to perform a high pass filtering on the filtered signal received, and send the filtered signal to the power amplifier 308.

The power amplifier 308 is adapted to perform power amplification on the filtered signal received, and send an amplified signal to the duplexer 309.

The duplexer 309 is adapted to perform a filtering again on the amplified signal received, and send the signal to a next ODU via the antenna 310.

During the process of realizing the functions, the up frequency conversion is performed once on the IF signal IF5 sent from the IDU to the ODU, and then the frequency of the microwave signal is directly output.

It should be noted that during the above-mentioned process, the up frequency converter 303 receives the local oscillator signal sent by the local oscillator 304, and performs the up frequency conversion on the IF signal sent by the IF amplifier to obtain the microwave signal. The frequency of the local oscillator signal is quite close to that of the microwave signal, so that the interference of the image frequency of the signal received on the microwave signal is relatively high. The local oscillator signal and the image frequency may be noise signals of the microwave signal after the frequency conversion. In order to filter the noise signals, in the embodiments of the present invention, the duplexer and the band pass filter composed of the low pass filter 306 and the high pass filter 307 are adapted to filter the noise signals. A frequency selection scope of the IF frequency IF5 restrains the local oscillator signal and the image frequency in a certain degree, so that in the embodiments of the present invention, the frequency selection scope of the IF frequency IF5 is usually between 300 MHz and 1000 MHz.

By the use of the frequency conversion sending device according to the embodiment of the present invention, frequency conversion of the digital microwave ODU once is realized, and the frequency conversion is easily realized. Further, the amount of components is reduced, thereby lowering the weight, volume, cost, and power consumption of the device. In the embodiment of the present invention, only two local oscillators are used, and thus the frequency configuration is more easily realized.

In a second embodiment of the present invention, the structure of the frequency conversion receiving device is further described by setting a receive link of an ODU as an example. Referring to FIG. 4, the frequency conversion receiving device includes an IF filter 410, an IF amplifier 409, a down frequency converter 408, a local oscillator 407, an amplifier 406, a low pass filter 405, a high pass filter 404, a low noise amplifier 403, a duplexer 402, and an antenna 401. Particularly, detailed principles and functions of each part in the frequency conversion receiving device are realized as follows.

The antenna 401 is adapted to receive the microwave signal sent by the previous ODU, and send the microwave signal to the duplexer 402.

The duplexer 402 is adapted to filter the microwave signal to extract useful signal, and send the useful signal to the low noise amplifier 403.

The low noise amplifier 403 is adapted to amplify the useful signal and send an amplified signal to the high pass filter 404.

The high pass filtering 404 is adapted to perform the high pass filtering on the amplified signal, and send a filtered signal to the low pass filter 405.

The low pass filter 405 is adapted to perform the low pass filtering on the signal received, and send the filtered signal to the down frequency converter 408.

The down frequency converter 408 is adapted to perform the frequency conversion on the filtered signal received to obtain an IF signal IF6, and send the signal to the IF amplifier 409. Particularly, the local oscillator 407 provides a radio frequency signal serving as a local oscillator signal, the amplifier 406 amplifies the local oscillator signal and sends the local oscillator signal to the down frequency converter 408, and the down frequency converter 408 performs the frequency conversion.

The IF amplifier 409 is adapted to amplify the IF signal IF6 received, and send the IF signal IF6 to the IF filter 410.

The IF filter 410 is adapted to filter the signal received, and send a filtered signal to the IDU for being processed.

Through the description of the functions, the down frequency conversion is performed once on the microwave signal received by the antenna to obtain an IF signal, and the IF signal is transmitted to the IDU for being processed via the IF cable.

It should be noted that in the receive link, the frequency of the microwave signal received by the antenna 401 is relatively high, and the frequency of the local oscillator signal provided by the local oscillator 407 is quite close to the frequency of the microwave signal, so the interference of the image frequency of the signal received on the microwave signal is relatively high. In order to sufficiently restrain the local oscillator signal and the image frequency, a frequency selection scope of the IF signal IF6 after the frequency conversion is usually between 140 MHz and 600 MHz. Further, in order to better filter the local oscillator signal and the image frequency, in the embodiment of the present invention, the duplexer 402 and the band pass filter composed of the high pass filter 404 and the low pass filter 405 are adapted to filter noise signals.

The IF frequency of the ODU is changed, so that the IF frequency of the IDU is correspondingly changed from the lower frequency to the same frequency as the IF transmitting and receiving frequencies of the ODU.

By the use of the frequency conversion receiving device according to the embodiment of the present invention, frequency conversion of the digital microwave ODU once is realized, and the frequency conversion is easily realized. Further, the amount of components is reduced, thereby lowering the weight, volume, cost, and power consumption of the device. In the embodiment of the present invention, only two local oscillators are used, so the frequency configuration is more easily realized.

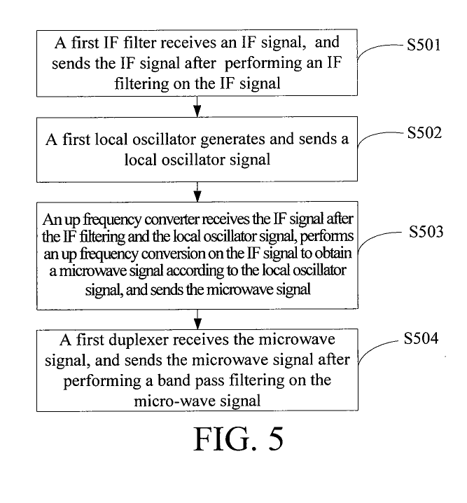

The present invention further provides a frequency conversion sending method. Referring to FIG. 5, the method includes the steps as follows.

In step S501, a first IF filter receives an IF signal, and sends the IF signal after performing an IF filtering on the IF signal.

In this step, the purpose of performing the IF filtering is filtering other noise signals except for the IF signal.

In step S502, a first local oscillator generates and sends a local oscillator signal.

Before the local oscillator signal is sent, the local oscillator signal may be amplified by an amplifier.

In step S503, an up frequency converter receives the IF signal after the IF filtering and the local oscillator signal, performs an up frequency conversion on the IF signal to obtain a microwave signal according to the local oscillator signal, and sends the microwave signal.

In step S504, a first duplexer receives the microwave signal, and sends the microwave signal after performing a band pass filtering on the microwave signal.

Before the first duplexer receives the microwave signal, the microwave signal may be amplified.

Preferably, a first band pass filter receives the microwave signal sent by the up frequency converter, and sends the filtered microwave signal to the first duplexer after performing the band pass filtering on the microwave signal. When the band pass filtering is performed on the microwave signal, a low pass filtering is performed on the microwave signal to remove the local oscillator signal, and a high pass filtering is performed on the microwave signal after performing the low pass filtering to remove an image frequency.

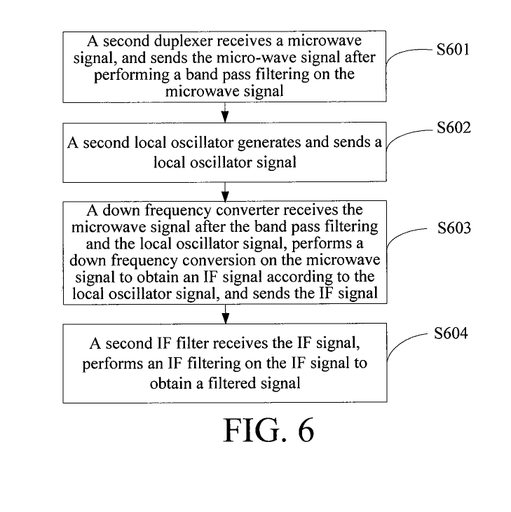

An embodiment of the present invention further provides a frequency conversion receiving method. Referring to FIG. 6, the method includes the steps as follows.

In step S601, a second duplexer receives a microwave signal, and sends the microwave signal after performing a band pass filtering on the microwave signal.

Before the band pass filtering is performed on the microwave signal and the microwave signal is sent, the microwave signal may be amplified.

In step S602, a second local oscillator generates and sends a local oscillator signal.

Before the local oscillator signal is sent, the local oscillator signal may be amplified by an amplifier.

In step S603, a down frequency converter receives the microwave signal after the band pass filtering and the local oscillator signal, performs a down frequency conversion on the microwave signal to obtain an IF signal according to the local oscillator signal, and sends the IF signal.

In step S604, a second IF filter receives the IF signal, performs an IF filtering on the IF signal to obtain a filtered signal.

In this step, the purpose of performing the IF filtering on the microwave signal is filtering other noise signals except for the IF signal.

Preferably, a second band pass filter receives the microwave signal sent by the second duplexer, and sends the microwave signal to the down frequency converter after performing the band pass filtering on the microwave signal.

When the second band pass filter performs the band pass filtering on the microwave signal received from the second duplexer, a high pass filtering is performed on the microwave signal to remove an image frequency, and a low pass filtering is performed on the microwave signal after performing the high pass filtering to remove the local oscillator signal.

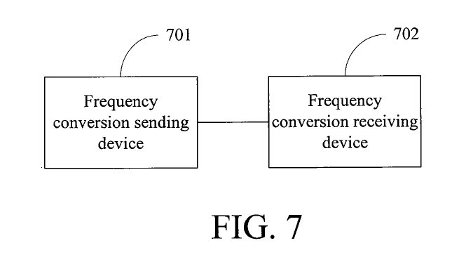

An embodiment of the present invention further provides a frequency conversion system. Referring to FIG. 7, the system includes a frequency conversion sending device 701 and a frequency conversion receiving device 702.

The frequency conversion sending device 701 is adapted to receive an IF signal, perform an IF filtering on the IF signal, generate a local oscillator signal, perform an up frequency conversion on the IF signal after the IF filtering to obtain a microwave signal according to the local oscillator signal, and send the microwave signal after performing a band pass filtering on the microwave signal.

The frequency conversion receiving device 702 is adapted to receive the microwave signal from the frequency conversion sending device 701, perform the band pass filtering again on the microwave signal, generate a local oscillator signal, perform a down frequency conversion on the microwave signal after performing the band pass filtering again to obtain an IF signal according to the local oscillator signal, and perform the IF filtering on the IF signal to obtain a filtered signal.

By the use of the frequency conversion method and the system thereof according to the embodiments of the present invention, frequency conversion of the digital microwave ODU once is realized, and the frequency conversion is easily realized. Further, the amount of components is reduced, thereby lowering the weight, volume, cost, and power consumption of the device.

Through the description of the implementation manner, those skilled in the art may clearly know that the present invention may be realized by using the hardware, and may also be realized by using the software and the necessary hardware platform. Based on this understanding, the technical solution of the present invention may be realized in the software product form. The computer software product is stored in a non-volatile memory medium, such as a compact disc read only memory (CD-ROM), a universal serial bus (USB) disc, or a mobile hard disk, and includes several instructions adapted to enable a computer device (such as a personal computer, a server, or a network device) to execute the method according to each embodiment of the present invention.

It will be apparent to those skilled in the art that various modifications and variations can be made to the present invention without departing from the scope of the invention. In view of the foregoing, it is intended that the present invention cover modifications and variations of this invention provided that they fall within the scope of the following claims and their equivalents.

What is claimed is:

1. A frequency conversion sending device, comprising:
a first intermediate frequency (IF) filter, adapted to receive an IF signal, and send the IF signal after performing an IF filtering on the IF signal;
a first local oscillator, adapted to generate and send a local oscillator signal;
an up frequency converter, adapted to receive the IF signal after the IF filtering and the local oscillator signal, perform an up frequency conversion on the IF signal to obtain a microwave signal according to the local oscillator signal, and send the microwave signal; and
a first duplexer, adapted to receive the microwave signal, and send the microwave signal after performing a band pass filtering on the microwave signal.

2. The device according to claim 1, wherein between the up frequency converter and the first duplexer, the device further comprises:
a first band pass filter, adapted to receive the microwave signal from the up frequency converter, and send the microwave signal to the first duplexer after performing the band pass filtering on the microwave signal.

3. The device according to claim 2, wherein the first band pass filter comprises a low pass filter and a high pass filter,
the low pass filter is adapted to receive the microwave signal from the up frequency converter, and send the microwave signal to the high pass filter after performing a low pass filtering on the microwave signal to remove the local oscillator signal; and
the high pass filter is adapted to send the microwave signal to the first duplexer after performing a high pass filtering on the microwave signal received to remove an image frequency.

4. A frequency conversion receiving device, comprising:
a second duplexer, adapted to receive a microwave signal, and send the microwave signal after performing a band pass filtering on the microwave signal received;
a second local oscillator, adapted to generate and send a local oscillator signal;
a down frequency converter, adapted to receive the microwave signal after the band pass filtering and the local oscillator signal, perform a down frequency conversion on the microwave signal to obtain an intermediate frequency (IF) signal according to the local oscillator signal, and send the IF signal; and
a second IF filter, adapted to receive the IF signal, perform an IF filtering on the IF signal received to obtain a filtered signal.

5. The device according to claim 4, wherein between the down frequency converter and the second duplexer, the device further comprises:
a second band pass filter, adapted to receive the microwave signal sent by the second duplexer, and send the microwave signal to the down frequency converter after performing the band pass filtering on the microwave signal.

6. The device according to claim 5, wherein the second band pass filter specifically comprises a high pass filter and a low pass filter,
the high pass filter is adapted to receive the microwave signal sent by the second duplexer, and send the microwave signal to the low pass filter after performing a high pass filtering on the microwave signal to remove an image frequency; and
the low pass filter is adapted to send the microwave signal to the down frequency converter after performing a low pass filtering on the microwave signal received to remove the local oscillator signal.

7. A frequency conversion sending method, comprising:
receiving, by a first intermediate frequency (IF) filter, an IF signal, and sending the IF signal after performing an IF filtering on the IF signal;
generating and sending, by a first local oscillator, a local oscillator signal;
receiving, by an up frequency converter, the IF signal after the IF filtering and the local oscillator signal, performing an up frequency conversion on the IF signal to obtain a microwave signal according to the local oscillator signal, and sending the microwave signal; and
receiving, by a first duplexer, the microwave signal, and sending the microwave signal after performing a band pass filtering on the microwave signal.

8. The method according to claim 7, further comprising:
receiving, by a first band pass filter, the microwave signal from the up frequency converter, and sending the microwave signal to the first duplexer after performing the band pass filtering on the microwave signal.

9. The method according to claim 8, wherein the performing the band pass filtering on the microwave signal comprises:
performing a low pass filtering on the microwave signal to remove the local oscillator signal, and performing a high pass filtering on the microwave signal after performing the low pass filtering to remove an image frequency.

10. A frequency conversion receiving method, comprising:
receiving, by a second duplexer, a microwave signal, and sending the microwave signal after performing a band pass filtering on the microwave signal;
generating and sending, by a second local oscillator, a local oscillator signal;
receiving, by a down frequency converter, the microwave signal after the band pass filtering and the local oscillator signal, performing a down frequency conversion on the microwave signal to obtain an intermediate frequency (IF) signal according to the local oscillator signal, and sending the IF signal; and
receiving, by a second IF filter, the IF signal, performing an IF filtering on the IF signal to obtain a filtered signal.

11. The method according to claim 10, further comprising:
receiving, by a second band pass filter, the microwave signal after the band pass filtering from the second duplexer, and sending the microwave signal to the down frequency converter after performing the band pass filtering again on the microwave signal.

12. The method according to claim 11, wherein the performing the band pass filtering again on the microwave signal comprises:
performing a high pass filtering on the microwave signal received to remove an image frequency, and performing a low pass filtering on the microwave signal after performing the high pass filtering to remove the local oscillator signal.

13. A frequency conversion system, comprising:
a frequency conversion sending device, adapted to receive an intermediate frequency (IF) signal, perform an IF filtering on the IF signal, generate a local oscillator signal, perform an up frequency conversion on the IF signal after the IF filtering to obtain a microwave signal according to the local oscillator signal, and send the microwave signal after performing a band pass filtering on the microwave signal; and
a frequency conversion receiving device, adapted to receive the microwave signal from the frequency conversion sending device, perform the band pass filtering again on the microwave signal, generate a local oscillator signal, perform a down frequency conversion on the microwave signal after performing the band pass filtering again to obtain an IF signal according to the local oscillator signal, and perform the IF filtering on the IF signal to obtain a filtered signal.
